(19) United States
(12) Patent Application Publication
(10) Pub. No.: US 2016/0053803 A1
(43) Pub. Date: Feb. 25, 2016

(54) ELASTIC SHORT-PIN TYPE UNIVERSAL JOINT

(71) Applicant: RE-DAI Precision Tools Co., LTD., TAICHUNG CITY (TW)

(72) Inventor: HSIANG CHEN YU, Taichung City (TW)

(21) Appl. No.: 14/554,138

(22) Filed: Nov. 26, 2014

(30) Foreign Application Priority Data
Aug. 22, 2014 (TW) 103129050

(51) Int. Cl. F16C 11/06; F16C 11/08

(52) U.S. Cl. CPC F16C 11/0614; F16C 11/08; F16C 11/0604

(57) ABSTRACT

An elastic short-pin type universal joint comprises a first base, a second base and a connection member. The connection member has a first hole, a second hole, a third hole and a fourth hole each being disposed at the same level from the connection member. Wall surfaces of the first base and the second base have slots corresponding to the holes, respectively. An elastic assembly is disposed in each hole, and one end of each elastic assembly rests against one slot. Thus, the length of the connection member can be shortened, and the length or size of the universal joint can be reduced. In addition, each elastic assembly can be easily and rapidly installed.

### BACKGROUND OF THE INVENTION

1. Field of the Invention

The invention relates to the technical field of a universal joint, and more particularly to an elastic short-pin type universal joint structure using four elastic short pins connected to a first base, a second base and a connection member.

2. Related Art

A typical universal joint comprises a first base (male base), a second base (female base), and a connection member disposed between the first base and the second base. More particularly, one long pin penetrates through the first base and the connection member, and the other long pin penetrates through the second base and the connection member.

Because two long pins are inserted into the connection member at different levels and the insertion directions of the two long pins are perpendicular to each other, the connection member has two through holes at different levels to be penetrated by the two long pins. For example, each of U.S. Pat. Nos. 8,746,113; 6,843,579; and 5,660,491 discloses the combination structure of the connection member and the two long pins.

In addition, Taiwan Patent Publication No. 200905097 discloses a universal joint using a long pin connected to a connection member, a first base and a second base in conjunction with two short pins. Furthermore, a shaft rod is inserted into the two short pins in the axial directions of the short pins and into the long pin in the radial direction of the long pin. Each of Taiwan Patent Publication Nos. 200905098 and 200907193 discloses a connection member connected to a first base and a second base in conjunction with four short pins. Furthermore, a screw member is concurrently screwed to the four short pins to prevent each short pin from moving out. The short pin in each of the patents needs to penetrate through the first base and the second base. So, each of the surfaces of the first base and the second base has a through hole. In addition, each short pin needs to work in conjunction with the positioning member, such as the shaft rod or screw member, to form the combined and positioned structure.

### SUMMARY OF THE INVENTION

An object of the invention is to provide an elastic short-pin type universal joint capable of reducing the overall size or length.

Another object of the invention is to provide an elastic short-pin type universal joint capable of making the overall assembling processes become simpler and more rapid.

To achieve the above-identified objects and effects, the invention provides a universal joint comprising a first base, a second base and a connection member. The connection member has a first hole, a second hole, a third hole and a fourth hole. Each hole is disposed on the same level from the connection member. Wall surfaces of the first base and the second base are formed with slots corresponding to the holes, respectively, and an elastic assembly is disposed in each hole. One end of each elastic assembly rests against one slot. Because each hole is disposed on the same level from the connection member, the length or size of the connection member can be reduced, so that the length or overall size of the universal joint can be reduced.

Also, the first base, the second base and the connection member are connected together through the elastic assembly. Furthermore, the elastic assembly is a combination of a spring and a short pin, wherein the spring is mounted in the hole, one end of the short pin is disposed in the hole, and the other end of the short pin is disposed in the slot so that the installation of the elastic assembly is easy and rapid.

### BRIEF DESCRIPTION OF THE DRAWINGS

FIG. 1 shows an exploded view according to a first embodiment of the invention.

FIG. 2 shows a schematic view of a structure of a first base according to the first embodiment of the invention.

FIG. 3 shows a schematic view of a structure of a second base according to the first embodiment of the invention.

FIG. 4 shows a schematic view of a combination structure of the connection member and each elastic assembly according to the first embodiment of the invention.

FIG. 5 shows a schematic view of a combination structure of the connection member, each elastic assembly and each lug according to the first embodiment of the invention.

FIGS. 6 and 7 show schematic views of combination structures of the members according to the first embodiment of the invention.

FIG. 8 shows an exploded view according to a second embodiment of the invention.

FIG. 9 shows an exploded view according to a third embodiment of the invention.

FIG. 10 shows a schematic view of structures of the connection member and each elastic assembly according to the third embodiment of the invention.

FIG. 11 shows a schematic view of a combination structure of the connection member, each elastic assembly and each lug according to the third embodiment of the invention.

### DETAILED DESCRIPTION OF THE INVENTION

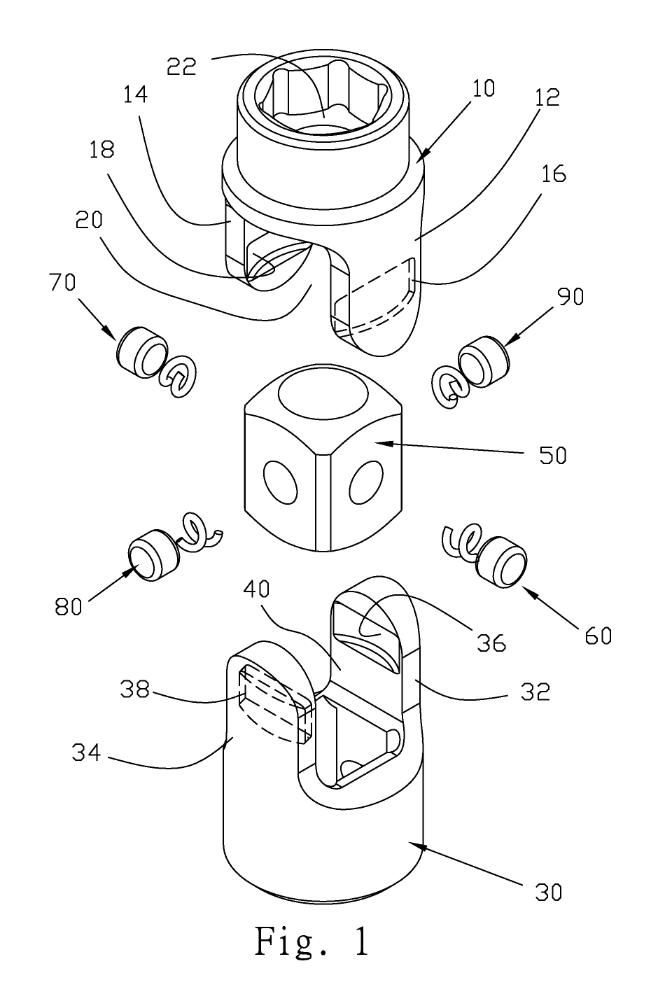

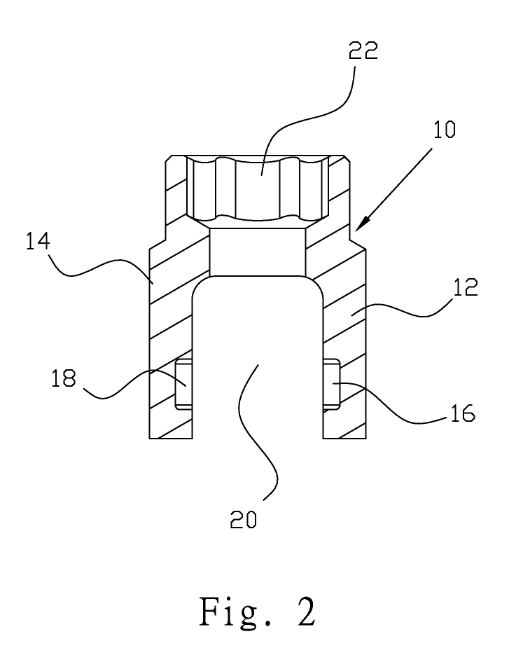

Referring to FIGS. 1 and 2, the universal joint of the invention has a first base 10 in the form of a yoke. One end of the first base 10 has a first lug 12 and a second lug 14 opposite to the first lug 12. A first slot 16 is formed on an inner wall surface of the first lug 12, and a second slot 18 is formed on an inner wall surface of the second lug 14. Also, a first chamber 20 is formed between the first lug 12 and the second lug 14. The other end of the first base 10 is formed with a sleeve portion 22. It is to be noted that the first lug 12 and the second lug 14 have no through hole.

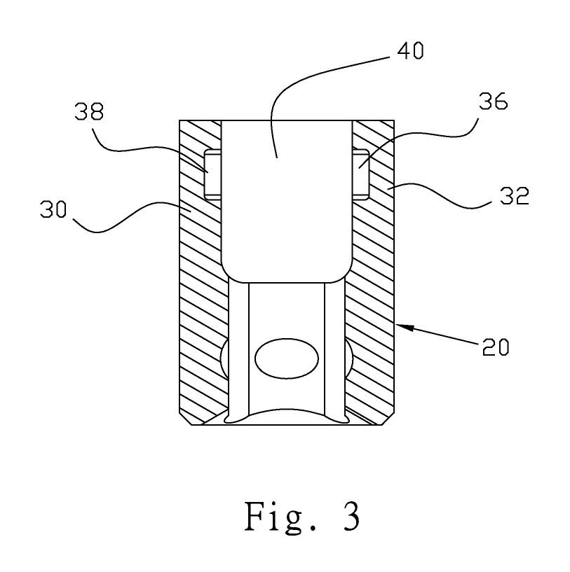

Referring to FIGS. 1 and 3, the invention comprises a second base 30 in the form of a yoke. Furthermore, one end of the second base 30 has a third lug 32 and a fourth lug 34 opposite to the third lug 32. A third slot 36 is formed on an inner wall surface of the third lug 32, and a fourth slot 38 is formed on an inner wall surface of the fourth lug 34. Furthermore, a second chamber 40 is formed between the third lug 32 and the fourth lug 34. It is to be noted that the third lug 32 and the fourth lug 34 have no through hole.

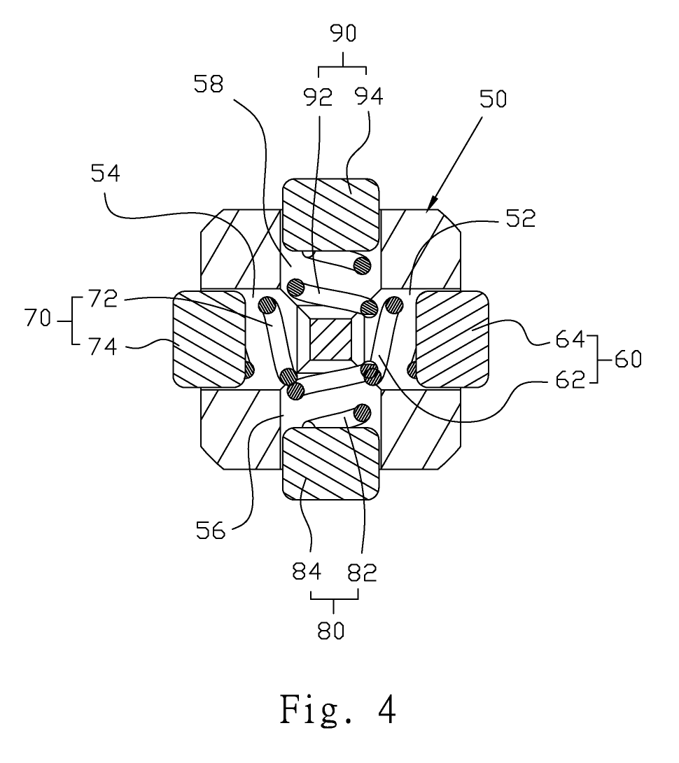

Referring to FIG. 1, the invention has a connection member 50, which is mounted in the first chamber 20 and the second chamber 40 and connects the first base 10 to the second base 30. Furthermore, as shown in FIG. 4, the connection member 50 has a first hole 52, a second hole 54, a third hole 56 and a fourth hole 58. The first hole 52 is disposed on an opposite facing surface of the second hole 54, and the third hole 56 is disposed on an opposite facing surface of the fourth hole 58. The first hole 52, the second hole 54, the third hole 56 and the fourth hole 58 are disposed on the same level from the connection member 50. In addition, the first hole 52, the second hole 54, the third hole 56 and the fourth hole 58 do not communicate with each other.

Referring to in FIG. 1, the invention has a first elastic assembly 60, a second elastic assembly 70, a third elastic assembly 80 and a fourth elastic assembly 90. Each elastic assembly is mounted in the hole of the connection member 50.

Referring to FIG. 4, the first elastic assembly 60 is a combination of a spring 62 and a short pin 64. The spring 62 is mounted in the first hole 52, one portion of the short pin 64 enters the first hole 52, and one end of the short pin 64 rests against the spring 62.

The second elastic assembly 70 is a combination of a spring 72 and a short pin 74. The spring 72 is mounted in the second hole 54. One portion of the short pin 74 enters the second hole 54, and one end of the short pin 74 rests against the spring 72.

The third elastic assembly 80 is a combination of a spring 82 and a short pin 84. The spring 82 is mounted in the third hole 56. One portion of the short pin 84 enters the third hole 56, and one end of the short pin 84 rests against the spring 82.

The fourth elastic assembly 90 is a combination of a spring 92 and a short pin 94. The spring 92 is mounted in the fourth hole 58. One portion of the short pin 94 enters the fourth hole 58, and one end of the short pin 94 resting against the spring 92.

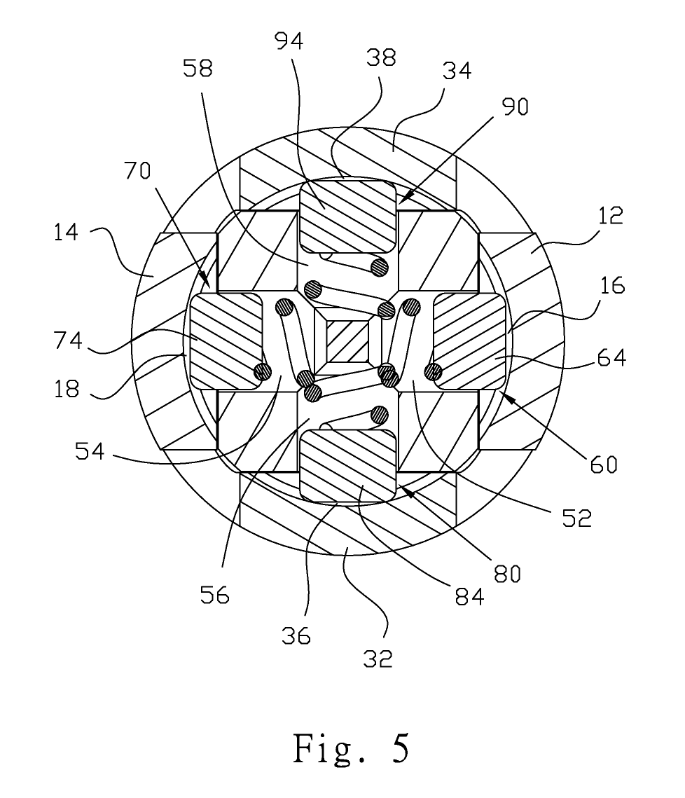

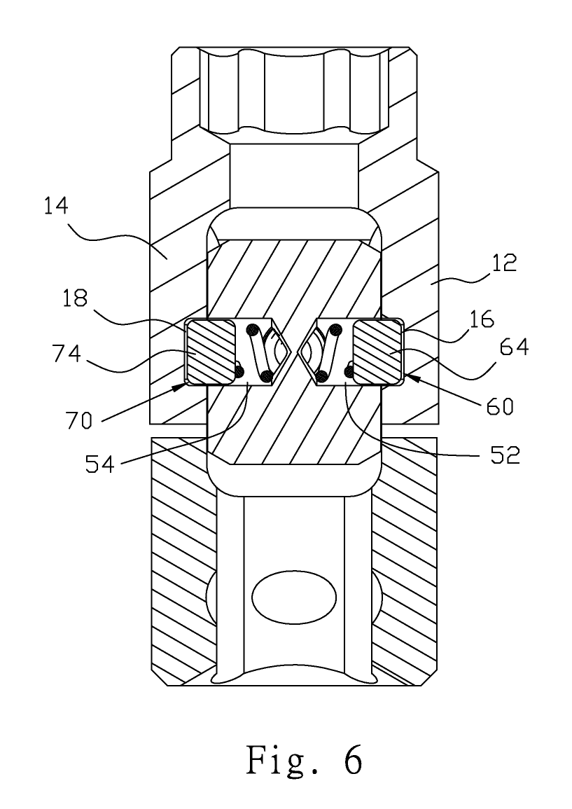

Referring to FIGS. 5 and 6, one portion of the short pin 64 of the first elastic assembly 60 is disposed on the first hole 52, and the other portion of the short pin 64 is disposed in the first slot 16 on the wall surface of the first lug 12. Similarly, one portion of the short pin 74 of the second elastic assembly 70 is disposed on the second hole 54, and the other portion of the short pin 74 is disposed in the second slot 18 on the wall surface of the second lug 14.

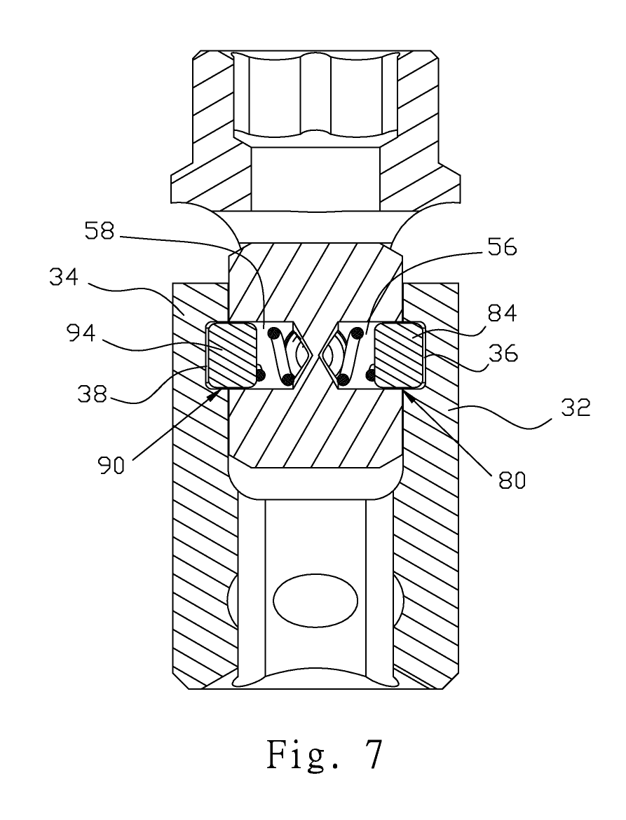

Referring to FIGS. 5 and 7, one portion of the short pin 84 of the third elastic assembly 80 is disposed in the third hole 56, and the other portion of the short pin 84 is disposed in the third slot 36 on the wall surface of the third lug 32. Similarly, one portion of the short pin 94 of the fourth elastic assembly 90 is disposed in the fourth hole 58, and the other portion of the short pin 94 is disposed in the fourth slot 38 on the wall surface of the fourth lug 34.

According to the above-mentioned descriptions, the connection member 50 can be connected to the first base 10 and the second base 30 in conjunction with the first elastic assembly 60, the second elastic assembly 70, the third elastic assembly 80 and the fourth elastic assembly 90. More particularly, the first hole 52, the second hole 54, the third hole 56 and the fourth hole 58 are disposed on the same level from the connection member 50, so no level difference has to be formed between holes of different axial directions. Therefore, the length or size of the connection member 50 can be accordingly decreased, and the overall length or size of the universal joint can be reduced.

Furthermore, the short pins 64, 74, 84 and 94 are mounted in the holes 52, 54, 56 and 58 in conjunction with the springs 62, 72, 82 and 92, respectively, and can elastically rest against the slots 16, 18, 36 and 38, respectively. Thus, each of the short pins 64, 74, 84 and 94 can be easily and rapidly installed.

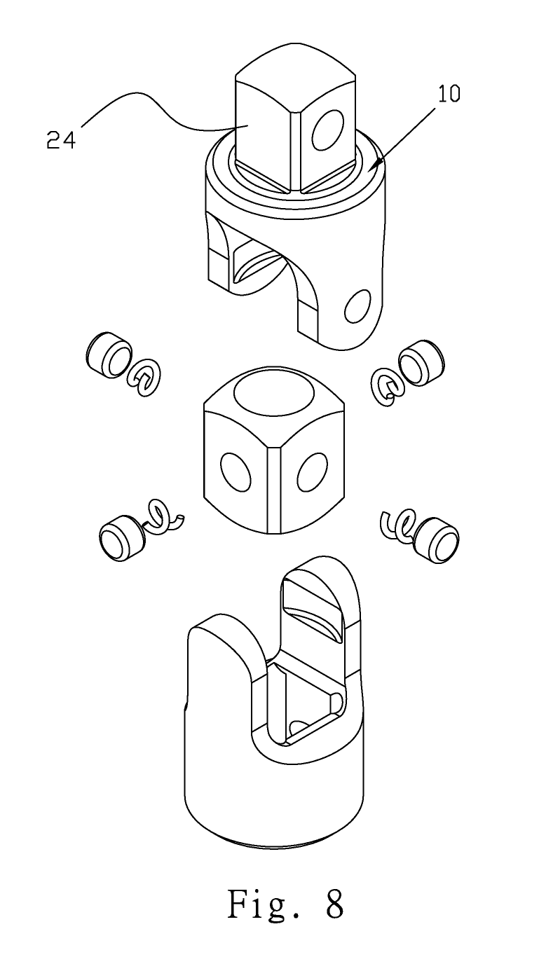

Referring to FIG. 8, one end of the first base 10 of the invention can be formed with a cylinder portion 24 to be connected to a sleeve or a tool having a sleeve structure.

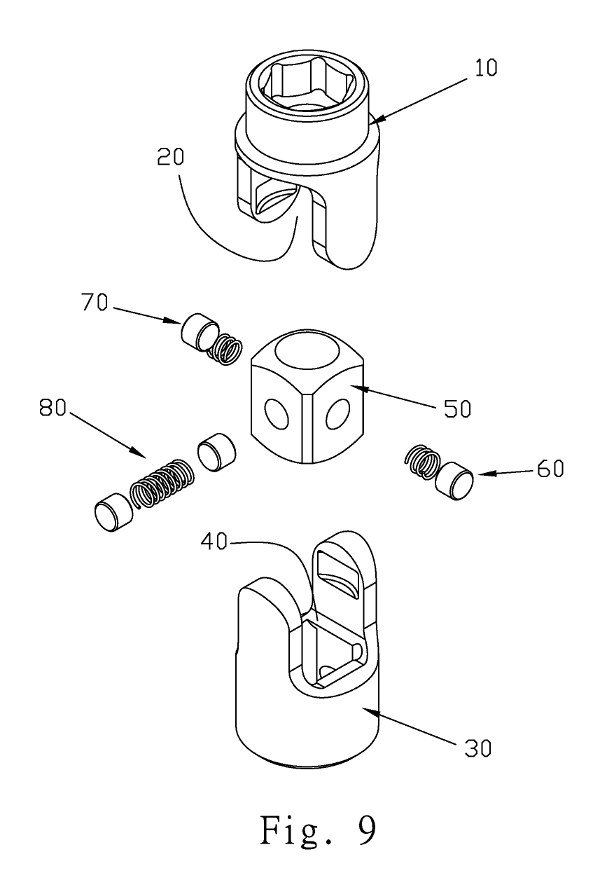

Referring to FIG. 9 showing another embodiment of the invention, the connection member 50 is mounted in the first chamber 20 of the first base 10 and the second chamber 40 of the second base 30. Furthermore, the connection member 50 connects the first base 10 to the second base 30 in conjunction with a first elastic assembly 60, a second elastic assembly 70 and a third elastic assembly 80.

The structures of the first base 10 and the second base 30 of this embodiment are the same as those of the previous embodiment, wherein the structure of the connection member 50 is simply modified and connects the first base 10 to the second base 30 in conjunction with three elastic assemblies 60, 70 and 80.

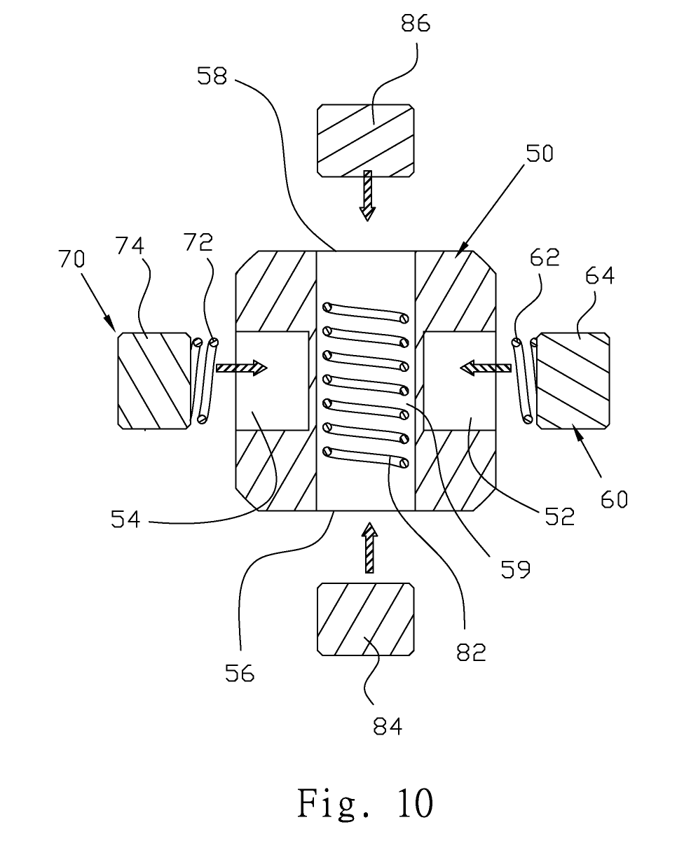

Referring to FIG. 10, the connection member 50 has a first hole 52, a second hole 54, a third hole 56 and a fourth hole 58. The first hole 52 is disposed on an opposite facing surface of the second hole 54, and the third hole 56 is disposed on an opposite facing surface of the fourth hole 58. The first hole 52, the second hole 54, the third hole 56 and the fourth hole 58 are disposed on the same level from the connection member 50, wherein the third hole 56 communicates with the fourth hole 58 to form a channel 59; the first hole 52 and the second hole 54 do not communicate with each other; and the first hole 52 and the second hole 54 do not communicate the channel 59 constituted by the third hole 56 and the fourth hole 58.

The first elastic assembly 60 is composed of a spring 62 and a short pin 64. The spring 62 is mounted in the first hole 52, one portion of the short pin 64 enters the first hole 52 and rests against the spring 62. The second elastic assembly 70 is composed of a spring 72 and a short pin 74. The spring 72 is mounted in the second hole 54, and one portion of the short pin 74 enters the second hole 54 and rests against the spring 72.

The third elastic assembly 80 is a combination of a spring 82 and two short pins 84 and 86. The spring 82 is mounted in the channel 59 constituted by the third hole 56 and the fourth hole 58. The two short pins 84 and 86 are mounted in the third hole 56 and the fourth hole 58, respectively. One end of each of the short pins 84 and 86 rests against the spring 82.

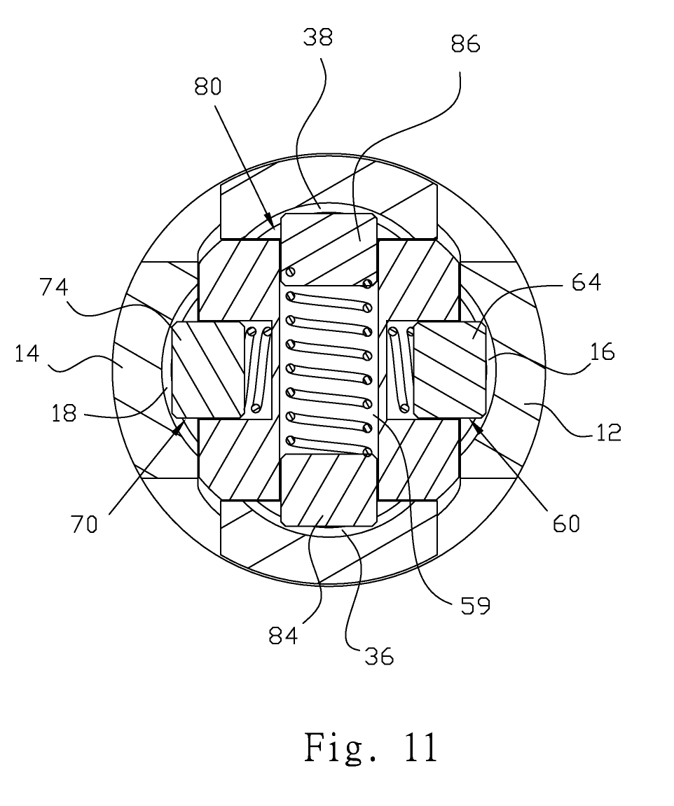

Referring to FIG. 11, one end of the short pin 64 of the first elastic assembly 60 enters the first slot 16 of the first lug 12; one end of the short pin 74 of the second elastic assembly 70 enters the first slot 18 of the second lug 14; and the short pins 84 and 86 on two ends of the third elastic assembly 80 enter the third slot 36 and the fourth slot 38, respectively. The short pins 64, 74, 84 and 86 can rest against the slots 16, 18, 36 and 38, respectively.

According to the above-mentioned descriptions, the first hole 52, the second hole 54, the third hole 56 and the fourth hole 58 are disposed on the same level from the connection member 50, so no level difference needs to be formed between the holes in different axial directions, so that the length or size of the connection member 50 can be reduced, and the overall length or size of the universal joint can be reduced.

Also, the short pins 64, 74, 84 and 86 are mounted in the first hole 52, the second hole 54 and the channel 59 in conjunction with the springs 62, 72 and 82, respectively, and elastically rest against the slots 16, 18, 36 and 38, respectively. So, each of the short pins 64, 74, 84 and 86 can be easily and rapidly installed.

What is claimed is:

1. An elastic short-pin type universal joint, comprising:
a first base having a first lug and a second lug opposite to the first lug, wherein a first slot is formed on an inner wall surface of the first lug, a second slot is formed on an inner wall surface of the second lug, and a first chamber is formed between the first lug and the second lug;
a second base having a third lug and a fourth lug opposite to the third lug, wherein a third slot is formed on an inner wall surface of the third lug, a fourth slot is formed on an inner wall surface of the fourth lug, and a second chamber is formed between the third lug and the fourth lug;
a connection member, which is mounted in the first chamber and the second chamber and has a first hole, a second hole, a third hole and a fourth hole, wherein the first hole is disposed on an opposite facing surface of the second hole, the third hole is disposed on an opposite facing surface of the fourth hole, the first hole, the second hole, the third hole and the fourth hole are disposed on the same level from the connection member, and the first hole, the second hole, the third hole and the fourth hole do not communicate with each other;
a first elastic assembly, which is mounted in the first hole and has one end resting against the first slot;
a second elastic assembly, which is mounted in the second hole and has one end resting against the second slot;
a third elastic assembly, which is mounted in the third hole and has one end resting against the third slot; and
a fourth elastic assembly, which is mounted in the fourth hole and has one end resting against the fourth slot.

2. The universal joint according to claim 1, wherein the first elastic assembly is a combination of a short pin and a spring, the spring is mounted in the first hole, one portion of the short pin enters the first hole and rests against the spring, and the other end of the short pin enters the first slot.

3. The universal joint according to claim 1, wherein the second elastic assembly is a combination of a short pin and a spring, the spring is mounted in the second hole, one portion of the short pin enters the second hole and rests against the spring, and the other end of the short pin enters the second slot.

4. The universal joint according to claim 1, wherein the third elastic assembly is a combination of a short pin and a spring, the spring is mounted in the third hole, one portion of the short pin enters the third hole and rests against the spring, and the other end of the short pin enters the third slot.

5. The universal joint according to claim 1, wherein the fourth elastic assembly is a combination of a short pin and a spring, the spring is mounted in the fourth hole, one portion of the short pin enters the fourth hole and rests against the spring, and the other end of the short pin enters the fourth slot.

6. An elastic short-pin type universal joint, comprising:
a first base having a first lug and a second lug opposite to the first lug, wherein a first slot is formed on an inner wall surface of the first lug, a second slot is formed on an inner wall surface of the second lug, and a first chamber is formed between the first lug and the second lug;
a second base having a third lug and a fourth lug opposite to the third lug, wherein a third slot is formed on an inner wall surface of the third lug, a fourth slot is formed on an inner wall surface of the fourth lug, and a second chamber is formed between the third lug and the fourth lug;
a connection member, which is mounted in the first chamber and the second chamber, and has a first hole, a second hole, a third hole and a fourth hole, wherein the first hole is disposed on an opposite facing surface of the second hole, the third hole is disposed on an opposite facing surface of the fourth hole, and the first hole, the second hole, the third hole and the fourth hole are disposed on the same level from the connection member, wherein the third hole communicates with the fourth hole to form a channel, the first hole does not communicate with the second hole, and the first hole and the second hole do not communicate with the third hole and the fourth hole;
a first elastic assembly, which is mounted in the first hole and has one end resting against the first slot;
a second elastic assembly, which is mounted in the second hole and has one end resting against the second slot; and
a third elastic assembly, which is mounted in the channel connecting the third hole to the fourth hole, wherein two ends of the third elastic assembly rest against the third slot and the fourth slot, respectively.

7. The universal joint according to claim 6, wherein the first elastic assembly is a combination of a short pin and a spring, the spring is mounted in the first hole, one portion of the short pin enters the first hole and rests against the spring, and the other end of the short pin enters the first slot.

8. The universal joint according to claim 6, wherein the second elastic assembly is a combination of a short pin and a spring, the spring is mounted in the second hole, one portion of the short pin enters the second hole and rests against the spring, and the other end of the short pin enters the second slot.

9. The universal joint according to claim 6, wherein the third elastic assembly is a combination of two short pins and a spring, the spring is mounted in the channel constituted by the third hole and the fourth hole, the two short pins are mounted in the third hole and the fourth hole, respectively, each of the short pins rests against the spring, one end of one of the short pins enters the third slot, and one end of the other one of the short pins enters the fourth slot.

10. The universal joint according to claim 1, wherein one end of the first base is a cylinder portion or a sleeve portion.

11. The universal joint according to claim 6, wherein one end of the first base is a cylinder portion or a sleeve portion.
